(19) United States
(12) Patent Application Publication
(10) Pub. No.: US 2006/0179613 A1
(43) Pub. Date: Aug. 17, 2006

(54) Knob for furniture

(76) Inventors: Horst Lautenschlager, Reinheim (DE); Earl David Forest, Asheboro, NC (US); Christopher D. Wolfe, High Point, NC (US)

Correspondence Address: Edgar A. Zarins;Masco Corporation, 21001 Van Born Road, Taylor, MI, 48180, US

(21) Appl. No.: 11/339,362

(22) Filed: Jan. 25, 2006

(30) Foreign Application Priority Data
Jan. 26, 2005 (DE) 10 2005 003 539.6

(51) Int. Cl. E05B 1/00

(52) U.S. Cl. 16/417

(57) ABSTRACT

A knob for furniture consists of a knob head (2), on the underside of which a knob base (3) protrudes. The knob head and base include a hollow cavity(s) resulting in a reduction of material requirements in the manufacture of the knob. Within a central cavity (5) in the knob base (3), there is a threaded hole (7) to accommodate a fastener screw (8). The threaded bore is disposed at a distance from the underside end of the knob base creating the cavity which results in the material savings during manufacture.

### BACKGROUND OF THE INVENTION

I. Field of the Invention

This invention relates to a knob for furniture having a knob head on the underside of which there protrudes a knob base and, on particular, to a knob having a substantially hollow construction with an open threaded hole on the underside to accommodate a securing screw.

II. Description of the Prior Art

Knobs of this sort have long been known in various designs. They are particularly used on furniture for drawers and furniture doors and serve to move the furniture parts to which they are attached. Frequently the knob base is designed narrower than the upper part of the knob as described here. This facilitates the user exerting tension on the knob because the user can grip the knob, which is broader than the base.

Such knobs are currently attached to their furniture parts by means of a securing screw that is screwed into a threaded hole on the underside. In known knobs, the knob body is solid allowing the threaded hole to be located immediately on the underside of the knob base. The knob base is otherwise made in a solid piece, which results in an increased requirement for material for the knob.

### SUMMARY OF THE PRESENT INVENTION

The present invention overcomes the disadvantages of the prior art by providing a knob which can be readily secured to the furniture piece but can be produced with a low requirement for material.

This goal is achieved by the invention in that the threaded hole is located at a distance from the underside of the knob base within a central cavity in the base. The central cavity in the knob base constitutes an empty space, which significantly reduces the requirement of material for the knob, but without affecting the appearance or the function of the knob. Since the threaded hole is located at a distance from the underside of the knob base, the securing screw must be made longer than with the arrangement of the threaded hole immediately at the underside of the knob base. This necessary extension of the securing screw, however, is associated with a comparatively slight requirement for additional material, which is more than compensated for by material savings from the central cavity of the knob base.

In a preferred embodiment of the invention it is provided that the knob base extends up to an upper wall of the knob head and is surrounded on the underside of the knob head by an open annular space. This annular space achieves an extra saving in material. The annular space can be supported by several radial ribs. These ribs accomplish a stiffening of the entire knob and thus permit further reduction in the wall thickness in both the knob head as well as the knob base. Preferably, the central cavity which acts as a guide for the fastener extends over more than half the height of the knob to achieve significant savings in materials in the knob base.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a longitudinal sectional view through a knob embodying the present invention;

FIG. 2 is a sectional view through an alternative knob with an annular space surrounding the knob base,

FIG. 3 is a sectional view of a still further embodiment of a knob with the radial ribs in the annular space;

FIG. 4 is an end view of the knob in FIG. 3 in the direction of arrow IV;

FIG. 5 is a cross-sectional view of a further embodiment of the knob; and

FIG. 6 is a cross-sectional view of a further embodiment of the knob.

### DETAILED DESCRIPTION OF A PREFERRED EMBODIMENT OF THE PRESENT INVENTION

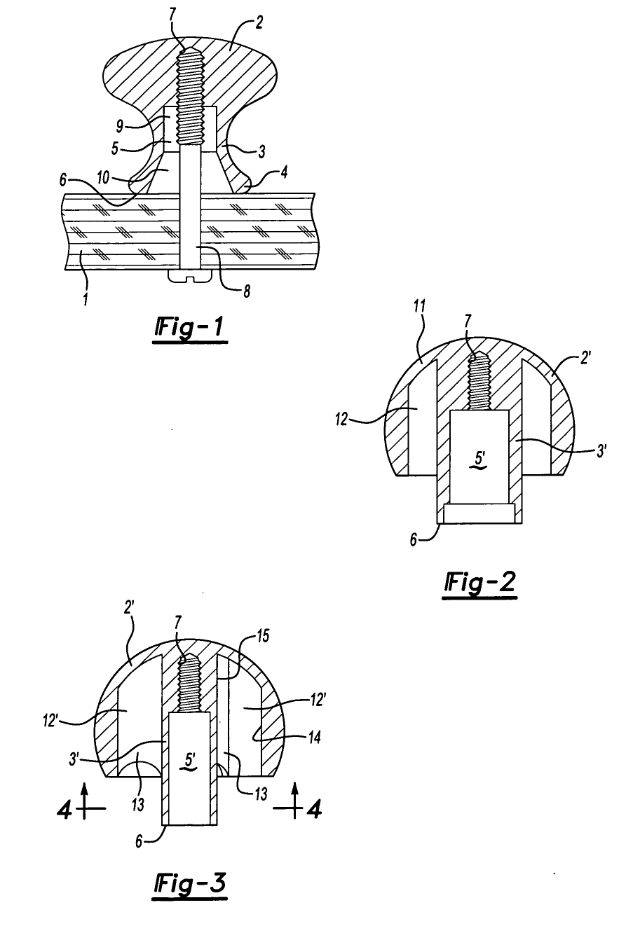

The knob shown in longitudinal section in FIG. 1 is intended for mounting on a piece of furniture that is indicated by the phantom lines, for example, the front facing of a piece of furniture or a drawer. The knob includes a knob head 2 which in this embodiment is made as a rounded shape although the body could be any common configuration. On the underside of knob head 2 there extends a knob base 3, which in this exemplary embodiment includes a skirt 4 adjacent to the outer surface of furniture part 1.

A central cavity 5 is formed within the knob base 3 during the manufacture of the knob, extending from the underside 6 of knob base 3. At the inner end of the cavity 5 is a threaded bore 7 opening downward to the underside of the knob. A fastener 8, shown in phantom in FIG. 1, extends out of furniture part 1 centrally through cavity 5 to threadably engage threaded bore 7, in order to fasten the knob to furniture part 1.

The embodiment shown in FIG. 1 shows the central cavity 5 communicating with the threaded bore 7 and with an additional cavity forming a cylinder 9. This part reaches to the underside 6 of the knob in a broadening section 10 having a frustoconical shape. The shape of the central cavity 5 thus conforms closely to the outer contour of knob base 3 so that the knob base 3 is altogether relatively thin walled. This reduction in material by creating the cavity 5 results in a cost savings in association with manufacture of the knob.

In the embodiment shown in FIG. 2, the knob 2′ is made as a portion of a sphere. The outer contour of knob base 3′ is essentially cylindrical and extends upward to an upper wall 11 of knob head 2′ and is surrounded on the underside of knob head 2′ by an open annular space 12. The central cavity 5′ of knob base 3′ thus constitutes a cylinder through a significant part of its length and extends—as in the embodiment according to FIG. 1—over more than half the height of the knob head. The internal diameter of the central cavity 5′ of the rotationally symmetrical knob base 3′ approximates the diameter of the base 3′, preferably 60-80% of the diameter of the knob base 3′, resulting in a thin-walled cylindrical knob base 3′ over the greatest part of its length.

FIG. 2 shows that the central cavity 5′ can be made with a greater diameter at the lower part 6 of knob base 3′ than in its other parts so that the underside 6 constitutes a very narrow annular surface on which knob base 4′ rests against the furniture part. The relatively high surface pressure achieved at this contact surface means that the outer surface of furniture part 1 is slightly compressed and the knob is consequently held immobile.

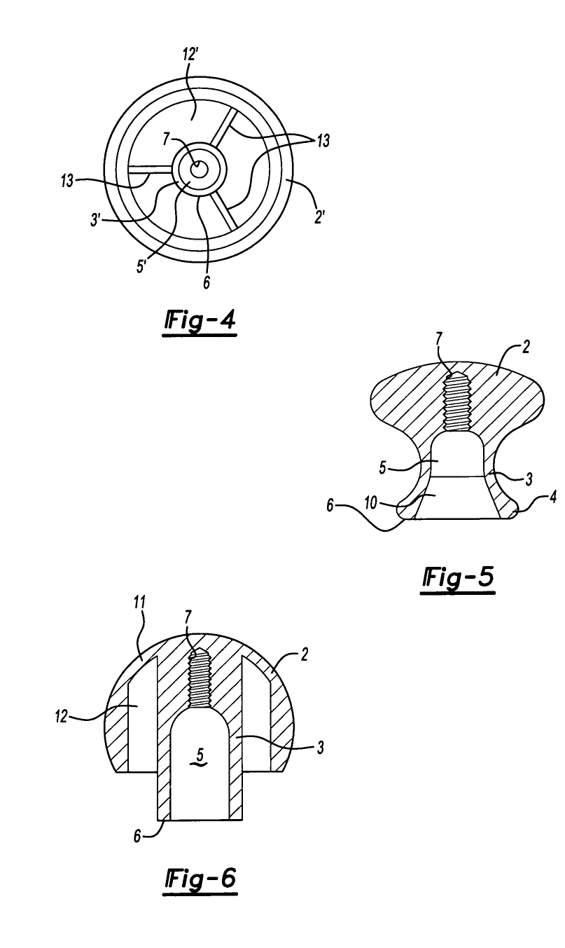

The embodiments represented in FIGS. 3 and 4 differ from the embodiment shown in FIG. 2 only in that annular space 12′ is supported by a plurality of radial ribs 13, which extend from inner wall 14 of knob head 12′ to the outer side 15 of knob base 3′. These ribs 13 increase the strength of the knob without substantially increasing the material requirements to manufacture the knob.

In a still further embodiment illustrated in FIGS. 5 and 6, the cavity 5 has a domed configuration to facilitate insertion of the fastener 8 into the bore 7. By utilizing a curved end wall to the cavity 5, the fastener 8 is guided to the bore 7 rather than possibly catching the square shoulder surrounding the bore 7 in the other embodiments.

Thus, the present invention improves over the furniture knob constructions of the prior art by reducing the amount of material, typically a metal, needed to form the knob. The threaded bore 7 which receives the mounting fastener 8 is moved nearly to the top of the knob allowing for creation of the cavity 5 resulting in less material. In a preferred embodiment, the cavity 5 extends through more than half of the knob diameter to realize the material savings.

The foregoing detailed description has been given for clearness of understanding only and no unnecessary limitations should be understood therefrom as some modifications will be apparent to those skilled in the art without departing from the scope and spirit of the appended claims.

What is claimed is:

1. A knob for furniture having a knob head with a knob base on the underside thereof, the knob having an open threaded hole on its underside to accommodate a fastener, the improvement comprising a threaded hole (7) spaced a distance from an end (6) of the knob base (3, 3′) at the bottom of a central cavity (5, 5′) of knob base (3, 3′).

2. The knob in accordance with claim 1, characterized in that the knob base (3′) extends up to an upper wall (11) of the knob head (2′) and is surrounded at the underside of the knob head (2′) by an open annular space (12).

3. The knob in accordance with claim 1, characterized in that the annular space (12′) is divided by a plurality of radial ribs (13).

4. The knob in accordance with claim 1, characterized in that the central cavity (5, 5′) extends over more than half the height of the knob.

5. The knob in accordance with claim 1, characterized in that the central cavity (5, 5′) approximately forms a cylinder over at least a portion of its length.

6. The knob in accordance with claim 5 characterized in that the central cavity is dome-shaped to guide said fastener towards said bore.

7. The knob in accordance with claim 1, characterized in that the knob base (3, 3′) is rotationally symmetrical and that the inner diameter of the central cavity (5, 5′) is less than the diameter of the knob base (3, 3′).

8. A knob adapted to be mounted to a furniture piece using a fastener, said knob including a knob head and a knob base extending from said knob head, said knob comprising:
a central cavity formed in said knob base and a bore formed at the interior end of said cavity wherein said bore receives said fastener to secure said knob and said cavity has a diameter greater than the diameter of said fastener.

9. The knob as defined in claim 8 wherein said central cavity extends over more than half the height of the knob.

10. The knob as defined in claim 8 wherein said knob base extends up to an end wall of the knob head to form an annular cavity around said knob base.

11. The knob as defined in claim 8 wherein said central cavity has a thin outer wall for said knob base.

12. The knob as defined in claim 8 wherein said bore is threaded to threadably receive said fastener.

13. The knob as defined in claim 9 wherein said central cavity is dome-shaped to guide said fastener towards said bore.
